(19) United States
(12) Patent Application Publication
(10) Pub. No.: US 2026/0172861 A1
(43) Pub. Date: Jun. 18, 2026

(54) DATA TRANSMISSION METHOD, DATA RECEPTION METHOD AND APPARATUSES THEREOF

(71) Applicant: 1FINITY Inc., Kawasaki-shi (JP)

(72) Inventors: Jian ZHANG, Beijing (CN); Yosuke AKIMOTO, Kawasaki-shi (JP); Meiyi JIA, Beijing (CN)

(73) Assignee: 1FINITY Inc., Kawasaki-shi (JP)

(21) Appl. No.: 19/531,146

(22) Filed: Feb. 5, 2026

Related U.S. Application Data
(63) Continuation of application No. PCT/CN2023/112273, filed on Aug. 10, 2023.

(51) Int. Cl. H04W 24/08; H04L 5/00; H04W 24/10

(52) U.S. Cl. CPC H04W 24/08; H04L 5/0057; H04W 24/10

(57) ABSTRACT

A data transmission apparatus, configured in a terminal equipment, includes: first configuration processor circuitry configured with a first channel state information report and/or a second channel state information report, wherein the first channel state information report is related to layer 1/layer 2 triggered mobility, and the second channel state information report is not related to layer 1/layer 2 triggered mobility; determining processor circuitry configured to determine a priority/priorities of the first channel state information report and/or the second channel state information report; and a first transmitter configured to transmit the first channel state information report and/or the second channel state information report according to determined priority/priorities, wherein a priority of the first channel state information report is higher than a priority of the second channel state information report.

### CROSS-REFERENCE TO RELATED APPLICATION

This application is a continuation application under 35 U.S.C. 111 (a) of International Patent Application PCT/CN2023/112273 filed on Aug. 10, 2023, and designated the U.S., the entire contents of which are incorporated herein by reference.

### TECHNICAL FIELD

This disclosure relates to the field of communication technologies.

### BACKGROUND

Layer 1/layer 2 triggered mobility (LTM) has been studied by the 3GPP standard organization in Release 18 (Rel-18). For the Rel-18 LTM, the goal is to reduce the time needed in hand over interruption via cell switch based on layer 1/layer 2 signaling, thereby enabling faster switch from a serving cell (source cell) to a target cell.

It should be noted that the above description of the background art is merely provided for clear and complete explanation of this disclosure and for easy understanding by those skilled in the art. And it should not be understood that the above technical solution is known to those skilled in the art as it is described in the background art of this disclosure.

### SUMMARY

Layer 1/layer 2 triggered mobility (LTM) has been studied in Rel-18. For the Rel-18 LTM, the goal is to reduce the time needed in hand over interruption via cell switch based on layer 1/layer 2 signaling, thereby enabling faster switch from a serving cell (source cell) to a target cell. The target cell is a cell after switch, which may be a serving cell, or may be a non-serving cell. The hand over interruption refers to a time from the terminal equipment receives a cell switch command to the terminal equipment has performed uplink or downlink communication successfully for the first time with the target cell. Compared to legacy cell switch based on layer 3 signaling, cell switch based on layer 1/layer 2 signaling is able to further reduce hand over interruption. To achieve cell switch based on layer 1/layer 2 signaling, a terminal equipment measures multiple candidate cells, such as measuring layer 1 reference signal receiving power (L1-RSRP) of a synchronization signal and physical broadcast channel block (SS/PBCH Block, SSB), and reports measurement results to a source cell, such as transmitting a channel state information (CSI) report, and the source cell indicates to the terminal equipment via a cell switch command which candidate cell to switch (the indicated candidate cell becomes a target cell), and indicates beams used for uplink and downlink transmission on the target cell after the switch, which is, for example, a transmission configuration indication (TCI) state, wherein all of the source cell, candidate cell and target cell in Rel-18 LTM support the unified TCI state in Rel-17. Therefore, the TCI state indicated above is a unified TCI state.

In addition, in Rel-18 LTM, candidate cell configuration, measurement configuration and reporting configuration (CSI reporting configuration) are provided by the source cell to the terminal equipment before the cell switch command. The candidate cell configuration includes a radio resource control (RRC) configuration applied by the terminal equipment after being switched to the target cell, i.e. an RRC configuration of the target cell. The terminal equipment may immediately apply the RRC configuration of the target cell after the cell switch, thereby quickly completing successful uplink or downlink transmission with the target cell. The measurement configuration mainly includes a configuration of measurement reference signals (such as SSBs), and the CSI reporting configuration is used to configure information needed in reporting. For a specific RRC signaling structure, for example, the CSI reporting configuration is included in a serving cell configuration, while the measurement configuration is located outside of the serving cell configuration and a candidate cell configuration.

It was found by the inventors that in order to support Rel-18 LTM, a CSI report for a purpose of cell switch was introduced in Rel-18 LTM, which is called LTM CSI report for short. The contrast with LTM CSI report is a legacy CSI report. Wherein, for the legacy CSI report, one CSI report is associated with a priority value, and priority values with which different CSI reports are associated are different. When the terminal equipment needs to select a part of CSI reports in multiple CSI reports to transmit according to priority rules, the terminal equipment selects a part of CSI reports with higher priorities. Configuration of the CSI reports are provided to the terminal equipment. For example, the LTM CSI report and the legacy CSI report are configured independently.

As LTM CSI reports are newly introduced into Rel-18 LTM, how to determine priorities of the LTM CSI reports (including how to determine values of the priorities of the LTM CSI reports and how to determine a priority order between the LTM CSI report and the legacy CSI report) becomes a problem needing to be solved.

In order to solve at least one of the above problems, embodiments of this disclosure provide a data transmission method, a data reception method and apparatuses thereof.

According to one aspect of the embodiments of this disclosure, there is provided a data transmission method, applicable to a terminal equipment, the method including:
being configured with a first channel state (CSI) information report and/or a second CSI report, wherein the first channel state information report is related to layer 1/layer 2 triggered mobility, and the second channel state information report is not related to layer 1/layer 2 triggered mobility;
determining a priority/priorities of the first channel state information report and/or the second channel state information report; and
transmitting the first channel state information report and/or the second channel state information report according to determined priority/priorities.

According to another aspect of the embodiments of this disclosure, there is provided a data reception method, applicable to a network device, the method including:
configuring a first channel state information report and/or a second channel state information report to a terminal equipment, wherein the first channel state information report is related to layer 1/layer 2 triggered mobility, and the second channel state information report is not related to layer 1/layer 2 triggered mobility,
wherein the terminal equipment determines a priority/priorities of the first channel state information report and/or the second channel state information report; and
receiving the first channel state information report and/or the second channel state information report transmitted by the terminal equipment according to determined priority/priorities.

According to a further aspect of the embodiments of this disclosure, there is provided a data transmission apparatus, configured in a terminal equipment, wherein the data transmission apparatus includes:
a first configuration unit configured with a first channel state information report and/or a second channel state information report, wherein the first channel state information report is related to layer 1/layer 2 triggered mobility, and the second channel state information report is not related to layer 1/layer 2 triggered mobility;
a determining unit configured to determine a priority/priorities of the first channel state information report and/or the second channel state information report; and
a first transmitting unit configured to transmit the first channel state information report and/or the second channel state information report according to determined priority/priorities.

According to still another aspect of the embodiments of this disclosure, there is provided a data reception apparatus, configured in a network device, the data reception apparatus including:
a second configuration unit configured to configure a first channel state information report and/or a second channel state information report to a terminal equipment, wherein the first channel state information report is related to layer 1/layer 2 triggered mobility, and the second channel state information report is not related to layer 1/layer 2 triggered mobility, wherein the terminal equipment determines a priority/priorities of the first channel state information report and/or the second channel state information report; and
a second receiving unit configured to receive the first channel state information report and/or the second channel state information report transmitted by the terminal equipment according to determined priority/priorities.

According to yet another aspect of the embodiments of this disclosure, there is provided a communication system, including:
a network device configured to configure a first channel state information report and/or a second channel state information report; and
a terminal equipment configured with the first channel state information report and/or the second channel state information report by the network device, wherein the first channel state information report is related to layer 1/layer 2 triggered mobility, and the second channel state information report is not related to layer 1/layer 2 triggered mobility; configured to determine a priority/priorities of the first channel state information report and/or the second channel state information report; and configured to transmit the first channel state information report and/or the second channel state information report according to determined priority/priorities.

An advantage of the embodiments of this disclosure exists in that the terminal equipment is configured with a CSI report and/or a second CSI report, a priority/priorities of the first channel state information report and/or the second channel state information report is/are determined, and the first channel state information report and/or the second channel state information report is/are transmitted according to determined priority/priorities. Thus, ambiguities resulted from determining a priority of a CSI report may be avoided, and failures in transmission of the CSI report caused thereby may also be avoided.

With reference to the following description and drawings, the particular embodiments of this disclosure are disclosed in detail, and the principle of this disclosure and the manners of use are indicated. It should be understood that the scope of the embodiments of this disclosure is not limited thereto. The embodiments of this disclosure contain many alternations, modifications and equivalents within the spirits and scope of the terms of the appended claims.

Features that are described and/or illustrated with respect to one embodiment may be used in the same way or in a similar way in one or more other embodiments and/or in combination with or instead of the features of the other embodiments.

It should be emphasized that the term “comprises/comprising/includes/comprising” when used in this specification is taken to specify the presence of stated features, integers, steps or components but does not preclude the presence or addition of one or more other features, integers, steps, components or groups thereof.

### BRIEF DESCRIPTION OF THE DRAWINGS

Elements and features depicted in one drawing or embodiment of the disclosure may be combined with elements and features depicted in one or more additional drawings or embodiments. Moreover, in the drawings, like reference numerals designate corresponding parts throughout the several views and may be used to designate like or similar parts in more than one embodiments.

FIG. 1 is schematic diagram of a communication system of the embodiments of this disclosure;

FIG. 2 is a schematic diagram of a legacy CSI report of the embodiments of this disclosure;

FIG. 3 is a schematic diagram of a data transmission method of the embodiments of this disclosure;

FIG. 4 is a schematic diagram of transmitting the first CSI report and the second CSI report simultaneously/nonsimultaneously of the embodiments of this disclosure;

FIG. 5 is an exemplary diagram of determining priorities of the first CSI report and the second CSI report of the embodiments of this disclosure;

FIG. 6 is an exemplary diagram of determining a first priority value and/or a second priority value of the embodiments of this disclosure;

FIG. 7 is another exemplary diagram of determining the first priority value and/or the second priority value of the embodiments of this disclosure;

FIG. 8 is a further exemplary diagram of determining the first priority value and/or the second priority value of the embodiments of this disclosure;

FIG. 9 is still another exemplary diagram of determining the first priority value and/or the second priority value of the embodiments of this disclosure;

FIG. 10 is a schematic diagram of a data reception method of the embodiments of this disclosure;

FIG. 11 is a schematic diagram of a data transmission apparatus of the embodiments of this disclosure;

FIG. 12 is a schematic diagram of a data reception apparatus the embodiments of this disclosure;

FIG. 13 is a schematic diagram of a structure of a network device of the embodiments of this disclosure; and

FIG. 14 is a schematic diagram of a terminal equipment of the embodiments of this disclosure.

### DETAILED DESCRIPTION

These and further aspects and features of this disclosure will be apparent with reference to the following description and attached drawings. In the description and drawings, particular embodiments of the disclosure have been disclosed in detail as being indicative of some of the ways in which the principles of the disclosure may be employed, but it is understood that the disclosure is not limited correspondingly in scope. Rather, the disclosure includes all changes, modifications and equivalents coming within the spirit and terms of the appended claims.

In the embodiments of this disclosure, terms “first”, and “second”, etc., are used to differentiate different elements with respect to names, and do not indicate spatial arrangement or temporal orders of these elements, and these elements should not be limited by these terms. Terms “and/or” include any one and all combinations of one or more relevantly listed terms. Terms “contain”, “include” and “have” refer to existence of stated features, elements, components, or assemblies, but do not exclude existence or addition of one or more other features, elements, components, or assemblies.

In the embodiments of this disclosure, single forms “a”, and “the”, etc., include plural forms, and should be understood as “a kind of” or “a type of” in a broad sense, but should not defined as a meaning of “one”; and the term “the” should be understood as including both a single form and a plural form, except specified otherwise. Furthermore, the term “according to” should be understood as “at least partially according to”, the term “based on” should be understood as “at least partially based on”, except specified otherwise.

In the embodiments of this disclosure, the term “communication network” or “wireless communication network” may refer to a network satisfying any one of the following communication standards: long term evolution (LTE), long term evolution-advanced (LTE-A), wideband code division multiple access (WCDMA), and high-speed packet access (HSPA), etc.

And communication between devices in a communication system may be performed according to communication protocols at any stage, which may, for example, include but not limited to the following communication protocols: 1 G (generation), 2 G, 2.5 G, 2.75 G, 3 G, 4 G, 4.5 G, 5 G and new radio (NR), etc., and/or other communication protocols that are currently known or will be developed in the future.

In the embodiments of this disclosure, the term “network device”, for example, refers to a device in a communication system that accesses a user equipment to the communication network and provides services for the user equipment. The network device may include but not limited to the following devices: a base station (BS), an access point (AP), a transmission reception point (TRP), a broadcast transmitter, a mobile management entity (MME), a gateway, a server, a radio network controller (RNC), a base station controller (BSC), etc.

The base station may include but not limited to a node B (NodeB or NB), an evolved node B (eNodeB or eNB), and a 5 G base station (gNB), etc. Furthermore, it may include a remote radio head (RRH), a remote radio unit (RRU), a relay, or a low-power node (such as a femto, and a pico, etc.). The term “base station” may include some or all of its functions, and each base station may provide communication coverage for a specific geographical area. And a term “cell” may refer to a base station and/or its coverage area, depending on a context of the term.

In the embodiments of this disclosure, the term “user equipment (UE)” or “terminal equipment (TE) or terminal device” refers to, for example, an equipment accessing to a communication network and receiving network services via a network device. The user equipment may be fixed or mobile, and may also be referred to as a mobile station (MS), a terminal, a subscriber station (SS), an access terminal (AT), or a station, etc.

The terminal equipment may include but not limited to the following devices: a cellular phone, a personal digital assistant (PDA), a wireless modem, a wireless communication device, a hand-held device, a machine-type communication device, a lap-top, a cordless telephone, a smart cell phone, a smart watch, and a digital camera, etc.

For another example, in a scenario of the Internet of Things (IoT), etc., the terminal equipment may also be a machine or a device performing monitoring or measurement. For example, it may include but not limited to a machine-type communication (MTC) terminal, a vehicle mounted communication terminal, an industrial wireless device, a surveillance camera, a device to device (D2D) terminal, and a machine to machine (M2M) terminal, etc.

Moreover, the term “network side” or “network device side” refers to a side of a network, which may be a base station or one or more network devices including those described above. The term “user side” or “terminal side” or “terminal equipment side” refers to a side of a user or a terminal, which may be a UE, and may include one or more terminal equipments described above. “A device” may refer to a network device, and may also refer to a terminal equipment.

Scenarios in the embodiments of this disclosure shall be described below by way of examples; however, this disclosure is not limited thereto.

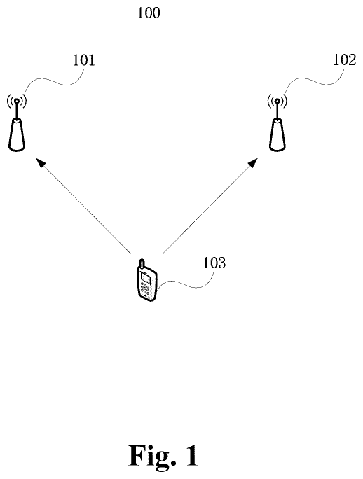

FIG. 1 is a schematic diagram of a communication system of the embodiments of this disclosure, in which a case where a terminal equipment and network devices are taken as examples is schematically shown. As shown in FIG. 1, the communication system 100 may include a first network device 101, a second network device 102 and a terminal equipment 103. For the sake of simplicity, an example having only two network devices and one terminal equipment is schematically given in FIG. 1. However, the embodiments of this disclosure are not limited thereto.

For example, the first network device 101 is a serving cell (source cell) of the terminal equipment 103, and the second network device 102 is a cell after the terminal equipment 103 is switched (target cell).

For legacy CSI reports, a CSI report is associated with a priority value, priority values with which different CSI reports are associated are different, and the smaller a priority value, the higher a priority. When the terminal equipment needs to select a part of CSI reports from multiple CSI reports to transmit according to priority rules, the terminal equipment selects in an order of priority values from small to large, that is, CSI reports with higher priorities are selected.

For example, for legacy CSI reports, a CSI report has a priority, which is used in priority rules. The terminal equipment preferentially transmits CSI reports with high priorities according to the priority rules, or omits CSI reports with low priorities, or discards the CSI reports with low priorities. A CSI report is associated with a priority value, the priority may be determined according to the priority value, and the smaller the priority value, the higher the priority. A CSI report includes CSI part 1, or CSI part 1 and CSI part 2.

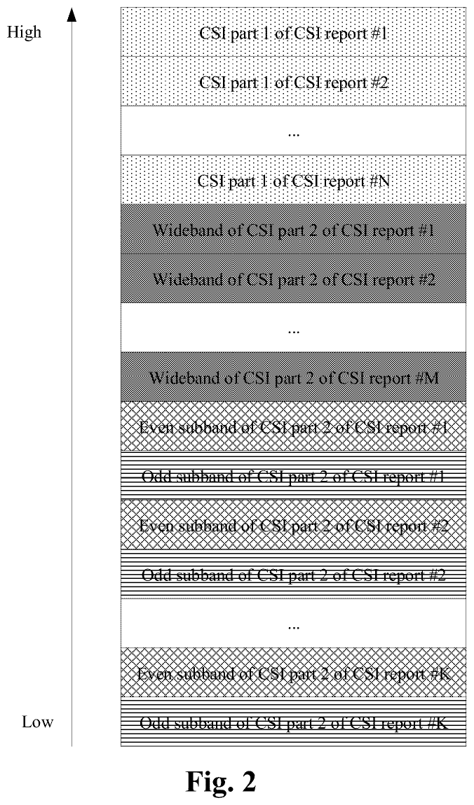

FIG. 2 is a schematic diagram of a legacy CSI report of the embodiments of this disclosure. For example, the terminal equipment needs to transmit multiple CSI reports simultaneously, and priorities of the CSI reports increases from bottom to top. If it is needed to select a part of CSI reports to transmit, the terminal equipment selects CSI reports with highest priorities to transmit.

For example, for the same CSI report, priorities of CSI part 1 and wideband of CSI part 2, even subband of CSI part 2 and odd subband of CSI part 2 sequentially decrease. For example, as shown in FIG. 2, for CSI report #1, the priority of CSI part 1 is higher than the wideband of CSI part 2, higher than the even subband of CSI part 2 and higher than the odd subband of CSI part 2. For different CSI reports, CSI reports with small priority values have higher priorities. For example, as shown in FIG. 2, CSI part 1 of CSI report #1 has a smaller priority value than CSI part 1 of CSI report #2, hence, CSI report #1 has a higher priority. In other words, for CSI part 1 of different CSI reports, priorities are determined according to priority values, the smaller the priority values, the higher the priorities. And a mapping order of the CSI (i.e. an order arrangement of parts of the CSI in the report of the terminal equipment) is also obtained according to the order of priority from high to low in FIG. 2.

It was found by the inventors that as LTM CSI reports are introduced into Rel-18 LTM and LTM CSI reports and legacy CSI reports are configured independently, how to determine priorities of the LTM CSI reports (including how to determine priority values of the LTM CSI reports and how to determine priority orders between the LTM CSI reports and the legacy CSI reports) is a problem needing to be solved.

For example, if a method for calculating the priority values of the legacy CSI reports is followed to calculate priority values of LTM CSI reports, ambiguities will occur in determining priority orders. For the legacy CSI reports, CSI report configuration IDs of different CSI reports are different, and priority values calculated according to different CSI report configuration IDs are also different. However, the LTM CSI reports and legacy CSI reports are configured independently, and values of the CSI report configuration IDs of the LTM CSI reports and the legacy CSI reports may both start from 0. Therefore, the LTM CSI reports and the legacy CSI reports may have identical CSI report configuration IDs, and priority values calculated according to identical CSI report configuration IDs are also identical. If the terminal equipment needs to transmit an LTM CSI report and a legacy CSI report simultaneously, and needs to select one of the LTM CSI reports and legacy CSI report with identical priority values to transmit, ambiguities will occur in selecting which CSI report. This is because it is impossible to determine a priority order according to the priority value at this time. If the terminal equipment and the network device have inconsistent understandings about which CSI report to be selected, a failure of transmission of the entire CSI report (including other uplink control information (UCI) multiplexed therewith) will be resulted.

In order to solve at least one of the above problems, embodiments of this disclosure provide a data transmission method, a data reception method and apparatuses thereof.

### EMBODIMENTS OF A FIRST ASPECT

The embodiments of this disclosure provide a data transmission method, applicable to a terminal equipment side.

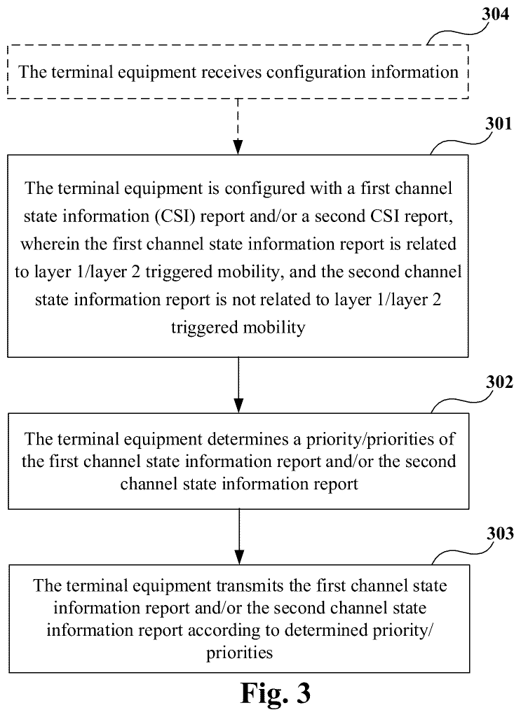

FIG. 3 is a schematic diagram of the data transmission method of the embodiments of this disclosure. As shown in FIG. 3, the method includes:

301: the terminal equipment is configured with a first channel state information (CSI) report and/or a second CSI report, wherein the first channel state information report is related to layer 1/layer 2 triggered mobility, and the second channel state information report is not related to layer 1/layer 2 triggered mobility;

302: the terminal equipment determines a priority/priorities of the first channel state information report and/or the second channel state information report; and

303: the terminal equipment transmits the first channel state information report and/or the second channel state information report according to determined priority/priorities.

The terminal equipment is configured with a CSI report and/or a second CSI report, a priority/priorities of the first channel state information report and/or the second channel state information report is/are determined, and the first channel state information report and/or the second channel state information report is/are transmitted according to determined priority/priorities. Thus, ambiguities resulted from determining a priority of a CSI report may be avoided, and failures in transmission of the CSI report caused thereby may also be avoided.

It should be noted that FIG. 3 only schematically illustrates the embodiments of this disclosure, and the terminal equipment is taken as an example; however, this disclosure is not limited thereto. For example, an order of execution of the operations may be appropriately adjusted, and furthermore, some other operations may be added, or some operation therein may be reduced. Furthermore, objects of the above operations may be adjusted. And appropriate variants may be made by those skilled in the art according to the above contents, without being limited to what is contained in FIG. 3.

In some embodiments, for example, terms ‘transmission configuration indication (TCI) state’ and ‘beam’ may be used interchangeably; ‘cell’ may be equivalently replaced with ‘carrier’ or ‘component carrier’; and “TCI state pool” may be equivalently replaced with “TCI state set” or “TCI state list”. The above are exemplary explanations only, and the embodiments of this disclosure are not limited thereto.

In some embodiments, the terminal equipment is configured with one or more candidate cells and provided with configuration information related to the candidate cells before receiving a cell switch command. Hence, the cell switch command indicates the terminal equipment to switch to the one or more candidate cells therein (i.e. target cells).

In some embodiments, a cell to which the terminal equipment belongs before the cell switch is referred to as “a serving cell” or “a source cell”, and a cell to which the terminal equipment belongs after the cell switch is referred to as “a target cell”. For example, the “serving cell” transmits the cell switch command to the terminal equipment, for example, the cell switch command is carried by a media access control control element (MAC CE). Thus, cell switch is indicated by layer 1 or layer 2 signaling, hence, the terminal equipment may quickly switch a cell. For example, reference may be made to the related art for an MAC CE format to which the cell switch command corresponds, which is not limited in this disclosure.

In some embodiments, the first CSI report is related to L1/L2 triggered mobility (LTM), and the second CSI report is not related to L1/L2 triggered mobility (LTM). For example, the first CSI report is a CSI report related to LTM, such as a CSI report for a purpose of LTM (purpose of cell switch). For example, the first CSI report may also be referred to as an LTM CSI report. The second CSI report is a CSI report not related to LTM, i.e. a CSI report for a non-LTM purpose, for example, the second CSI report may also be referred to as a legacy CSI report.

That the terminal equipment is configured with the first CSI report and/or the second CSI report shall be described below.

In some embodiments, the method further includes: 304: the terminal equipment receives configuration information, the configuration information configuring the first CSI report and/or the second CSI report. In some embodiments, the configuration information is carried by an RRC message.

For example, “the serving cell” of the terminal equipment transmits the configuration information via an information element (IE) in the RRC message, and the terminal equipment is configured with the first CSI report and/or the second CSI report according to the configuration information.

For example, the configuration information is carried by the IE in the RRC message. For example, “the serving cell” may configure the first CSI report and the second CSI report via the same IE in the configuration information, or “the serving cell” may configure the first CSI report and the second CSI report via different IEs in the configuration information; however, this disclosure is not limited thereto.

Table 1 below illustrates configuring the first CSI report and the second CSI report via different IEs in the configuration information.

TABLE 1

| | |
|---|---|
| CSI-MeasConfig ::= | SEQUENCE { |
| csi-ReportConfigToAddModList | SEQUENCE (SIZE (1..maxNrofCSI- |

ReportConfigurations)) OF CSI-ReportConfig OPTIONAL, -- Need N

| | |
|---|---|
| ltm-CSI-ReportConfigToAddModList | SEQUENCE (SIZE (1..maxNrofLTMCSI- |

ReportConfigurations)) OF LTM-CSI-ReportConfig OPTIONAL, -- Need N
}

| | |
|---|---|
| CSI-ReportConfigId ::= | INTEGER (0..maxNrofCSI-ReportConfigurations− |

1)

| | |
|---|---|
| LTM-CSI-ReportConfigId ::= | INTEGER (0..maxNrofLTMCSI- |

ReportConfigurations−1)

For example, Table 1 is specific IE contents of the configuration information of the embodiments of this disclosure. As shown in Table 1, the configuration information at least includes a first CSI report configuration (LTM-CSI-ReportConfig) and a second CSI report configuration (CSI-ReportConfig).

For example, the terminal equipment is configured with the first CSI report via the first CSI report configuration (LTM-CSI-ReportConfig). The first CSI report is a CSI report related to LTM, such as a CSI report performed for a purpose of LTM (purpose of cell switch). The terminal equipment may be provided with multiple first CSI report configurations, each of which being associated with a CSI report configuration ID (LTM-CSI-ReportConfigId), for example, the first CSI report may also be referred to as an LTM CSI report. For example, the terminal equipment is configured with the second CSI report via the second CSI report configuration (CSI-ReportConfig). The second CSI report is a CSI report not related to LTM, that is, a CSI report performed for a non-LTM purpose. The terminal equipment may be provided with multiple second CSI report configurations, each of which being associated with a CSI report configuration ID (CSI-ReportConfigId), for example, the second CSI report may also be referred to as a legacy CSI report.

In some embodiments, a first CSI report and/or a second CSI report is/are associated with a priority value. For example, each CSI report is associated with a priority value, the first CSI report is associated with a first priority value, i.e. a first priority value of the first CSI report, and the second CSI report is associated with a second priority value, i.e. a second priority value of the second CSI report.

In some embodiments, the priority/priorities of the first CSI report and/or the second CSI report is/are determined according to at least one of the following: a first priority value of the first CSI report; a second priority value of the second CSI report; or, a first rule.

In some embodiments, the smaller the first priority value, the higher a corresponding priority of the first CSI report, and/or the smaller the second priority value, the higher a corresponding priority of the second CSI report.

For example, within the first CSI report or the second CSI report, the smaller the first priority value, the higher the priority of the corresponding first CSI report; or, the lower the second priority value, the higher the priority of the corresponding second CSI report.

For example, within the first CSI report, a value range of the first priority value is an integer among 0 to N, and with the increase of the first priority value, the priority of the corresponding first CSI report decreases. For example, the priority of the first CSI report with the first priority value of “n1” is higher than that of the first CSI report with the first priority value of “n2”; where, n1<n2. A mode for determining a priority in the second CSI report is similar to that in the first CSI report, which shall not be repeated herein any further.

The above method is also applicable to determining priority order between the first CSI report and the second CSI report. For example, between the first CSI report and the second CSI report: the lower a first priority value, the higher a priority of a corresponding first CSI report, and the lower a second priority value, the higher a priority of a corresponding second CSI report.

For example, between the first CSI report and the second CSI report, in a case where the first priority value and the second priority value are different, for example, a priority of a first CSI report with a first priority value of “n1” is higher than that of a second CSI report with a second priority value of “m1”; where, n1<m1. In a cases where the first priority value and the second priority value are identical shall be described in detail later, which shall not be repeated herein any further.

In some embodiments, transmitting the first CSI report and/or the second CSI report includes: transmitting the first CSI report or the second CSI report whichever has a higher priority.

For example, the terminal equipment needs to transmit multiple CSI reports including the first CSI report and the second CSI report simultaneously, and needs to select part of the CSI reports to transmit. For example, the terminal equipment selects 5 CSI reports from 10 CSI reports including the first CSI report and the second CSI report to report. In a process of selecting a specific CSI report, such as in selecting a fifth one of five reported CSI reports, if the terminal equipment needs to select one CSI report of the first CSI report and the second CSI report to transmit, the terminal equipment selects a CSI report with a higher priority to transmit.

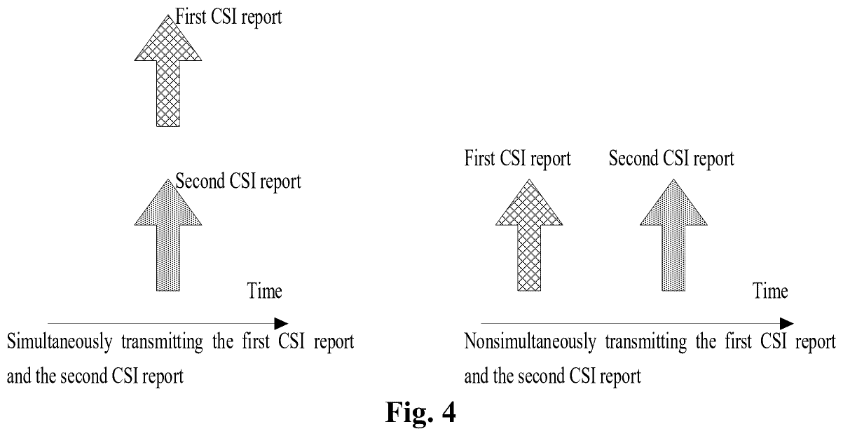

FIG. 4 is a schematic diagram of transmitting the first CSI report and the second CSI report simultaneously/nonsimultaneously of the embodiments of this disclosure. For example, as shown in the left of FIG. 4, the terminal equipment needs to transmit multiple CSI reports including the first CSI report and the second CSI report simultaneously in the time domain. For example, as shown in the right of FIG. 4, the terminal equipment may also transmit multiple CSI reports including the first CSI report and the second CSI report at different times in the time domain.

For example, that “the terminal equipment needs to transmit multiple CSI reports including the first CSI report and the second CSI report simultaneously” includes that “the terminal equipment transmits multiple CSI reports including the first CSI report and the second CSI report simultaneously in a cell”.

For example, when the terminal equipment needs to transmit multiple CSI reports including the first CSI report and the second CSI report simultaneously in the time domain, the terminal equipment needs to determine the priorities of the first CSI report and the second CSI report. How to determine “a CSI report with a higher priority in the first CSI report and the second CSI report” shall be described below.

For example, the terminal equipment determines the priority/priorities of the first CSI report and/or the second CSI report according to the first priority value of the first CSI report, the second priority value of the second CSI report and a first rule.

In some embodiments, the first rule includes that: in a case where the first priority value is identical to the second priority value, a priority of the first CSI report to which the first priority value corresponds is higher than the second CSI report to which the second priority value corresponds, or, in a case where the first priority value is identical to the second priority value, a priority of the second CSI report to which the second priority value corresponds is higher than the first CSI report to which the first priority value corresponds.

“In a case where the first priority value is identical to the second priority value, a priority of the first CSI report to which the first priority value corresponds is higher than the second CSI report to which the second priority value corresponds” shall be described below by way of examples.

For example, as the first CSI report and the second CSI report are configured independently, it is possible that the first priority value is identical to the second priority value. When the terminal equipment needs to select a CSI report (a CSI report with a higher priority) from the first CSI report and the second CSI report to transmit, for example, in a case where it needs to transmit the first CSI report and the second CSI report simultaneously, it can select only one of them to transmit. At this time, as the priority order of the priority of the first CSI report and the second CSI report is unable to be determined according to the priority values, the terminal equipment may follow the default first rule. For example, when the first priority value is identical to the second priority value, the terminal equipment always deems that the priority of the first CSI report to which the first priority value corresponds is higher than the priority of the second CSI report to which the second priority value corresponds. For example, it deems that the CSI report related to LTM has a higher priority, hence, it selects the first CSI report to transmit. When the first priority value is different from the second priority value, the CSI report with a smaller priority value still has a higher priority.

Therefore, the priorities of the first CSI report and the second CSI report may be determined, and a problem of ambiguities in determining the priorities of the CSI reports is solved.

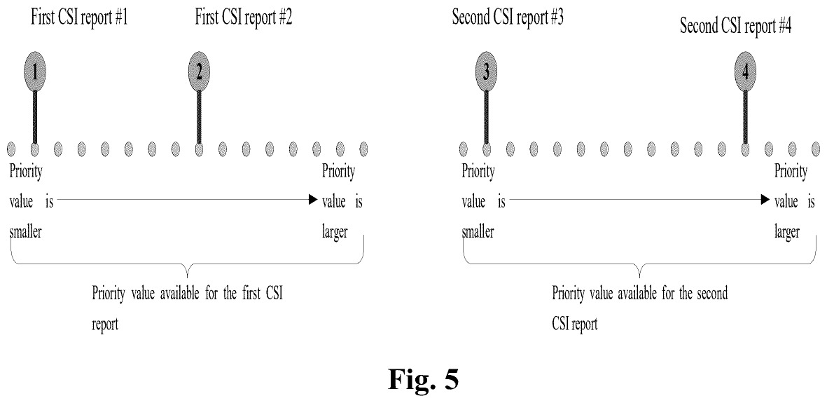

FIG. 5 is an exemplary diagram of determining the priorities of the first CSI report and the second CSI report of the embodiments of this disclosure. As shown in FIG. 5, for example, the first priority value of the first CSI report is identical to the second priority value of the second CSI report. As the priority values of first CSI report #1 and second CSI report #3 are identical, first CSI report #1 takes precedence over second CSI report #3; as second CSI report #3 has a lower priority value than first CSI report #2, second CSI report #3 takes precedence over first CSI report #2; and as first CSI report #2 has a lower priority value than second CSI report #4, first CSI report #2 takes precedence over second CSI report #4. Therefore, an order to the priorities of the first CSI report and the second CSI report may be determined from high to low as first CSI report #1, second CSI report #3, first CSI report #2, and second CSI report #4.

“In a case where the first priority value is identical to the second priority value, a priority of the second CSI report to which the second priority value corresponds is higher than the first CSI report to which the first priority value corresponds” shall be described below by way of examples.

For example, as the first CSI report and the second CSI report are configured independently, it is possible that the first priority value is identical to the second priority value. When the terminal equipment needs to select one CSI report (a CSI report with a higher priority) from the first CSI report and the second CSI report to transmit, for example, in a case where it needs to transmit the first CSI report and the second CSI report simultaneously, it can select only one of them to transmit. At this time, as the priority order of the priority of the first CSI report and the second CSI report is unable to be determined according to the priority values, the terminal equipment may follow the default first rule. For example, when the first priority value is identical to the second priority value, the terminal equipment always deems that the priority of the second CSI report to which the second priority value corresponds is higher than the first CSI report to which the first priority value corresponds. For example, it deems that the CSI report not related to LTM has a higher priority, hence, it selects the second CSI report to transmit. When the first priority value is different from the second priority value, the CSI report with a smaller priority value still has a higher priority.

For example, still taking FIG. 5 as an example, an order of the priorities of the first CSI report and the second CSI report from high to low is second CSI report #3, first CSI report #1, first CSI report #2, and second CSI report #4.

Therefore, the priorities of the first CSI report and the second CSI report may be determined, and the problem of ambiguity in determining the priorities of the CSI reports may be solved.

In some embodiments, the first rule includes: deeming that the priority of the first CSI report is higher than the priority of the second CSI report, or deeming that the priority of the second CSI report is higher than the priority of the first CSI report.

For example, the terminal equipment may follow the default first rule. For example, between the first CSI report and the second CSI report, the terminal equipment always deems that the priority of the first CSI report is higher than the priority of the second CSI report. For example, it deems that the CSI report related to LTM always has a higher priority, and within the first CSI report or the second CSI report, the priority of the first CSI report or the second CSI report is still determined according to the first priority value or the second priority value. For example, among multiple first CSI reports, the smaller the first priority value, the higher the priority of the corresponding first CSI report; and between among second CSI reports, the smaller the second priority value, the higher the priority of the corresponding second CSI report.

For example, still taking FIG. 5 as an example, an order of the priorities of the first CSI report and the second CSI report from high to low is first CSI report #1, first CSI report #2, second CSI report #3, and second CSI report #4.

Therefore, the priorities of the first CSI report and the second CSI report may be determined, and the problem of ambiguity in determining the priorities of the CSI reports may be solved.

For example, the terminal equipment may follow the default first rule. For example, between the first CSI report and the second CSI report, the terminal equipment always deems that the priority of the second CSI report is higher than the priority of the first CSI report. For example, it deems that the CSI report not related to LTM always has a higher priority, and within the first CSI report or the second CSI report, the priority of the first CSI report or the second CSI report is still determined according to the first priority value or the second priority value. For example, among multiple first CSI reports, the smaller the first priority value, the higher the priority of the corresponding first CSI report; and among multiple second CSI reports, the smaller the second priority value, the higher the priority of the corresponding second CSI report.

For example, still taking FIG. 5 as an example, an order of the priorities of the first CSI report and the second CSI report from high to low is second CSI report #3, second CSI report #4, first CSI report #1, and first CSI report #2.

Therefore, the priorities of the first CSI report and the second CSI report may be determined, and the problem of ambiguity in determining the priorities of the CSI reports may be solved.

In some embodiments, the being configured with first CSI report and/or the second CSI report includes: not expecting to be configured with the first CSI report and the second CSI report having identical priority values.

For example, the expression “the terminal equipment does not expect to be configured with the first CSI report and the second CSI report having identical priority values” may be replaced with “the terminal equipment expects to be configured with the first CSI report and the second CSI report having different priority values” or “the network device does not configure/does not schedule/does not indicate the first CSI report and the second CSI report having identical priority values” or “a serving cell does not configure/does not schedule/does not indicate the first CSI report and the second CSI report having identical priority values”; For example, “the first CSI report and the second CSI report having identical priority values” refers to that the first priority value of the first CSI report is equal to the second priority value of the second CSI report.

For example, the priority values of the first CSI report and the second CSI report are dependent on the CSI report configuration. For example, for the configuration shown in Table 1, the terminal equipment does not expect to be provided with a first CSI report configuration (LTM-CSI-ReportConfig) and a second CSI report configuration (CSI-ReportConfig) that makes the first priority value identical to the second priority value. When the first priority value is different from the second priority value, a CSI report with a smaller priority value has a higher priority. Therefore, by restricting not allowing to configure the terminal equipment with the first CSI report and the second CSI report having identical priority values, the problem of ambiguity resulted from determining priorities of CSI reports is solved.

For another example, the priority values of the first CSI report and the second CSI report are dependent on one or more parameters related to the CSI report configuration (or in the CSI report configuration). When at least one of the parameters is configured as being different, the priority values of the two CSI reports are different.

For example, the one or more parameters related to the CSI report configuration (or in CSI report configuration) at least include “a CSI report configuration ID”.

In some embodiments, the being configured with the first CSI report and/or the second CSI report includes: not expecting to be configured with the first CSI report and the second CSI report having identical CSI report configuration IDs.

In some embodiments, the not expecting to be configured with the first CSI report and the second CSI report having identical priority values includes: not expecting to be configured with the first CSI report and the second CSI report having identical CSI report configuration IDs.

For example, the expression “the terminal equipment does not expect to be configured with the first CSI report and the second CSI report having identical CSI report configuration IDs” may be replaced with “the terminal equipment expects to be configured with the first CSI report and the second CSI report having different CSI report configuration IDs” or “the network device does not configure/does not schedule/does not indicate the first CSI report and the second CSI report having identical CSI report configuration IDs” or “the serving cell does not configure/does not schedule/does not indicate the first CSI report and the second CSI report having identical CSI report configuration IDs.

For example, “the first CSI report and the second CSI report having identical priority values” refers to that the first priority value of the first CSI report is equal to the second priority value of the second CSI report.

For example, the one or more parameters related to the CSI report configuration (or in the CSI report configuration) at least include “a CSI report configuration ID”. When “the CSI report configuration IDs” of the first CSI report and the second CSI report are configured to be different values, the first priority value of the first CSI report is different from the second priority value of the second CSI report. When the first priority value is different from the second priority value, a CSI report with a smaller priority value has a higher priority.

For example, for the configuration shown in Table 1, such as “maxNrofLTMCSI-ReportConfigurations”= “maxNrofCSI-ReportConfigurations”=N, maximum numbers of first CSI reports and second CSI reports are identical. By configuring different “CSI report configuration IDs” for the terminal equipment, a total number of the first CSI reports and the second CSI reports does not exceed N, that is, it is still equal to the maximum number of CSI reports before the introduction of LTM (N), hence, there is no need to introduce new terminal equipment capabilities; and when “configuring different CSI report configuration IDs for the terminal equipment” is not limited, the total number of the first CSI reports and the second CSI reports may reach 2 N at most, and new terminal equipment capabilities need to be introduced to support higher complexities.

Therefore, by limiting configuring the first CSI report and the second CSI report to correspond to different “CSI report configuration IDs” for the terminal equipment, the problem of ambiguity resulted in determining the priorities of the CSI reports may be solved, while further reducing the complexity of the terminal equipment, avoiding requiring the terminal equipment to support more CSI reports, and avoiding introduction of new terminal equipment capabilities.

In some embodiments, transmitting the first CSI report and/or the second CSI report includes: not expecting to simultaneously transmit the first CSI report and the second CSI report.

In some embodiments, the not expecting to simultaneously transmit the first CSI report and the second CSI report includes: not expecting to simultaneously transmit the first CSI report and the second CSI report in a cell.

For example, that “the terminal equipment does not expect to simultaneously transmit the first CSI report and the second CSI report” includes that: “the terminal equipment does not expect to simultaneously transmit the first CSI report and the second CSI report in a cell”.

For example, the expression “the terminal equipment does not expect to simultaneously transmit the first CSI report and the second CSI report” may be replaced with “the terminal equipment is not scheduled to simultaneously transmit the first CSI report and the second CSI report” or “the terminal equipment expects not to simultaneously transmit the first CSI report and the second CSI report” or “the network device does not configure/does not schedule/does not indicate to simultaneously transmit the first CSI report and the second CSI report” or “the serving cell does not configure/does not schedule/does not indicate to simultaneously transmit the first CSI report and the second CSI report”.

For example, still taking FIG. 4 as an example, that “the terminal equipment does not expect to simultaneously transmit the first CSI report and the second CSI report” includes that the terminal equipment does not expect to transmit the first CSI report and the second CSI report according to the example shown on the left of FIG. 4; or, that “the terminal equipment does not expect to simultaneously transmit the first CSI report and the second CSI report” includes that the network device is scheduled to transmit the first CSI report and the second CSI report according to the example shown on the right of FIG. 4.

For example, the network device indicates via dynamic signaling (such as an MAC control element (MAC CE) or downlink control information (DCI)) or semi-persistent signaling (such as an RRC message) to transmit the first CSI report and the second CSI report in the time domain.

As ambiguities in determining the priorities of the CSI reports are possibly generated only when the terminal equipment needs to simultaneously transmit the first CSI report and the second CSI report and the priority values of the first CSI report and the second CSI report are identical, by avoiding that the terminal equipment needs to simultaneously transmit the first CSI report and the second CSI report in scheduling, the terminal equipment does not need to compare the priorities of the first CSI report and the second CSI report, thereby solving the problem of ambiguities generated in determining the priorities of the CSI reports. Among multiple first CSI reports or among multiple second CSI reports, a CSI report with a smaller priority value still has a higher priority.

In some embodiments, transmitting the first CSI report and/or the second CSI report includes: not expecting to simultaneously transmit the first CSI report and the second CSI report having identical priority values.

In some embodiments, the not expecting to simultaneously transmit the first CSI report and the second CSI report having identical priority values includes: not expecting to simultaneously transmit the first CSI report and the second CSI report having identical priority values in a cell.

For example, the expression “the terminal equipment does not expect to simultaneously transmit the first CSI report and the second CSI report having identical priority values” may be replaced with “the terminal equipment is not scheduled to simultaneously transmit the first CSI report and the second CSI report having identical priority values” or “the network device does not configure/does not schedule/does not indicate to simultaneously transmit the first CSI report and the second CSI report having identical priority values” or “the serving cell does not configure/does not schedule/does not indicate to simultaneously transmit the first CSI report and the second CSI report having identical priority values”.

For example, “the first CSI report and the second CSI report having identical priority values” means that the first priority value of the first CSI report is equal to the second priority value of the second CSI report.

For example, by avoiding that the terminal equipment needs to simultaneously transmit the first CSI report and the second CSI report in scheduling, ambiguities in determining the priorities of the first CSI report and the second CSI report may be avoided. For example, the first CSI report and the second CSI report may have identical priority values, and the first CSI report and the second CSI report may possibly be scheduled simultaneously, but the terminal equipment will not be scheduled to simultaneously transmit the first CSI report and the second CSI report having identical priority values. In the case of different priority values, a CSI report having a smaller priority value still has a higher priority.

For example, that “the terminal equipment does not expect to simultaneously transmit the first CSI report and the second CSI report having identical priority values” includes that the network device may schedule to simultaneously transmit the first CSI report and the second CSI report. For example, the network device indicates via dynamic signaling (such as an MAC control element (MAC CE) or downlink control information (DCI)) or semi-persistent signaling (such as an RRC message) to simultaneously transmit the first CSI report and the second CSI report, wherein priority values to which the first CSI report and the second CSI report transmitted simultaneously correspond are different, that is, the first priority value of the first CSI report is different from the second priority value of the second CSI report.

As ambiguities in determining the priorities of the CSI reports are possibly generated only when the terminal equipment needs to simultaneously transmit the first CSI report and the second CSI report and the priority values of the first CSI report and the second CSI report are identical, by avoiding that the terminal equipment needs to simultaneously transmit the first CSI report and the second CSI report having identical priority values in scheduling, that is, no ambiguity will be generated in the first CSI report and the second CSI report that are simultaneously transmitted by the terminal equipment, thereby solving the problem of ambiguities generated in determining the priorities of the CSI reports. In a case where the priority values are different, a CSI report with a smaller priority value still has a higher priority.

In some embodiments, transmitting the first CSI report and/or the second CSI report includes: not expecting to simultaneously transmit the first CSI report and the second CSI report having identical CSI report configuration IDs.

In some embodiments, the not expecting to simultaneously transmit the first CSI report and the second CSI report having identical CSI report configuration IDs includes: not expecting to simultaneously transmit the first CSI report and the second CSI report having identical CSI report configuration IDs in a cell.

For example, when “the CSI Report Configuration IDs” are different, priority values of corresponding CSI reports are different, and when the priority values are different, a CSI report with a smaller priority value still has higher priority. For example, the expression “the terminal equipment does not expect to simultaneously transmit the first CSI report and the second CSI report having identical CSI report configuration IDs” may be replaced with “the terminal equipment is not scheduled to simultaneously transmit the first CSI report and the second CSI report having identical CSI report configuration IDs” or “the network device does not configure/does not scheduled/does not indicate to simultaneously transmit the first CSI report and the second CSI report having identical CSI report configuration IDs” or “the serving cell does not configure/does not scheduled/does not indicate to simultaneously transmit the first CSI report and the second CSI report having identical CSI report configuration IDs”.

In some embodiments, the not expecting to simultaneously transmit the first CSI report and the second CSI report having identical priority values includes: not expecting to simultaneously transmit the first CSI report and the second CSI report having identical CSI report configuration IDs.

For example, the expression “the terminal equipment does not expect to simultaneously transmit the first CSI report and the second CSI report having identical priority values” may be replaced with “the terminal equipment does not expect to simultaneously transmit the first CSI report and the second CSI report having identical CSI report configuration IDs”.

As ambiguities in determining the priorities of the CSI reports are possibly generated only when the terminal equipment needs to simultaneously transmit the first CSI report and the second CSI report and the priority values of the first CSI report and the second CSI report are identical, by avoiding that the terminal equipment needs to simultaneously transmit the first CSI report and the second CSI report having identical CSI report configuration IDs in scheduling, that is, no ambiguity will be generated in the first CSI report and the second CSI report that are simultaneously transmitted by the terminal equipment, thereby solving the problem of ambiguities generated in determining the priorities of the CSI reports. In a case where the priority values are different, a CSI report with a smaller priority value still has a higher priority.

In some embodiments, the first priority value and/or the second priority value is/are determined according to at least one of the following: a CSI report configuration identifier; a serving cell index; a CSI report quantity; a CSI report configuration type; or, whether a CSI report is related to LTM.

In some embodiments, the first priority value and/or the second priority value is/are determined according to a parameter representing a CSI report configuration identifier, a parameter representing a serving cell index, a parameter representing a CSI report quantity, and a parameter representing a CSI report configuration type.

The first priority value and the second priority value are expressed as Pri_{CSI}, Pri_{CSI}being determined according to formula (1) below:

$$P r {i}_{CSI} ( y , k , c , s ) = {M}_{k} \cdot {N}_{c e l l s} \cdot {M}_{s} \cdot y + {N}_{c e l l s} \cdot {M}_{s} \cdot k + {M}_{s} \cdot c + s ; \qquad ( 1 )$$

where,

y denotes a CSI report configuration type, for example, for an aperiodic CSI report carried by a physical uplink shared channel (PUSCH), y=0; for a semi-persistent CSI report carried by a PUSCH, y=1; for a semi-persistent CSI report carried by a physical uplink control channel (PUCCH), y=2; and for a periodic CSI report carried by a PUCCH, y=3.

k denotes a CSI report quantity, Mₖ−1 denotes a maximum value of k; for example, for a CSI report carrying L1-RSRP or an L1-SINR (signal to interference plus noise ratio), k=0; for a CSI report not carrying L1-RSRP or an L1-SINR, k=1; here, Mₖ=2.

c denotes a serving cell index, and N_{cells}−1 denotes a maximum value of c; for example, c denotes a cell where a CSI report is located, that is, the CSI report is transmitted on a serving cell c; and N_{cells} is a parameter maxNrofSrevingCells configured by a higher layer, i.e. a maximum number of serving cells.

s denotes a CSI report configuration ID, and Mₛ−1 denotes a maximum value of s; for example, as shown in Table 1, for the first CSI report, s is a parameter LTM-CSI-ReportConfigId configured by a higher layer, and Mₛ is a parameter maxNrofLTMCSI-ReportConfigurations configured by a higher layer; and for the second CSI report, s is a parameter CSI-ReportConfigId configured by a higher layer, and Mₛ is a parameter maxNrofCSI-ReportConfigurations configured by a higher layer.

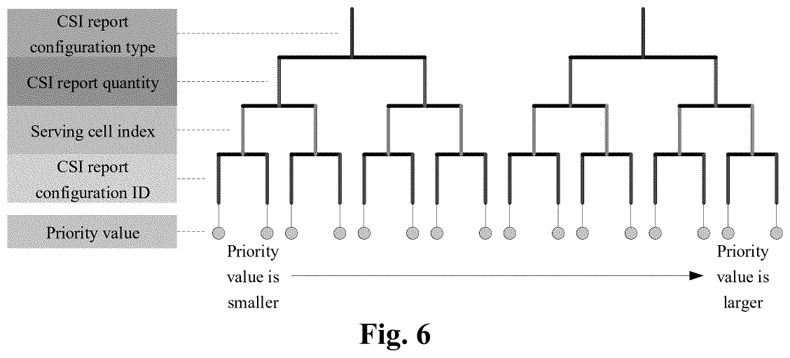

FIG. 6 is an exemplary diagram of determining the first priority value and/or the second priority value of the embodiments of this disclosure. For example, formula (1) may be expressed in a form of a tree diagram shown in FIG. 6, a CSI report corresponds to a lowest branch in the diagram and has one priority value; for example, both the first priority value and the second priority value may be determined according to formula (1).

For example, the first priority value or the second priority value is determined according to the mode shown in FIG. 6 and formula (1), according to a value range of Ms, values of the first priority value and the second priority value may possibly be identical, and the priorities of the first CSI report and the second CSI report may be determined according to a first rule as below. For example, the first rule includes that: in a case where the first priority value is identical to the second priority value, a priority of the first CSI report to which the first priority value corresponds is higher than the second CSI report to which the second priority value corresponds, or, in a case where the first priority value is identical to the second priority value, a priority of the second CSI report to which the second priority value corresponds is higher than the first CSI report to which the first priority value corresponds. In a case where priority values are different, a CSI report with a smaller priority value still has a higher priority.

Therefore, the priority values of the first CSI report and the second CSI report may be determined, thereby solving the problem of ambiguity in determining the priorities of the CSI reports.

In some embodiments, the first priority value and/or the second priority value is/are determined according to a parameter representing a CSI report configuration identifier, a parameter representing a serving cell index, a parameter representing a CSI report quantity and/or whether a CSI report is related to LTM or not, and a parameter representing a CSI report configuration type.

The first priority value and the second priority value are expressed as Pri_{CSI}, Pri_{CSI} being determined according to formula (2) below:

$$P r {i}_{CSI} ( y , k , c , s ) = {M}_{k} \cdot {N}_{c e l l s} \cdot {M}_{s} \cdot y + {N}_{c e l l s} \cdot {M}_{s} \cdot k + {M}_{s} \cdot c + s ; \qquad ( 2 )$$

where,
k denotes a CSI report quantity and/or whether a CSI report is related to LTM or not, Mₖ−1 denotes a maximum value of k; for example, for a CSI report carrying L1-RSRP or an L1-SINR and not related to LTM, k=1; for a CSI report not carrying L1-RSRP or an L1-SINR and not related to LTM, k=2; for a CSI report related to LTM, k=0; here, MR=3.

Which CSI report corresponds to a value of k is not limited in this disclosure. For example, the above three CSI reports may also be that: the CSI report carrying L1-RSRP or an L1-SINR and not related to LTM corresponds to k=0, the CSI report not carrying L1-RSRP or an L1-SINR and not related to LTM corresponds to k=1, and the CSI report related to LTM corresponds to k=2. For example, k may also be other values, which shall not be enumerated herein any further.

Definitions of other parameters are identical to those in formula (1).

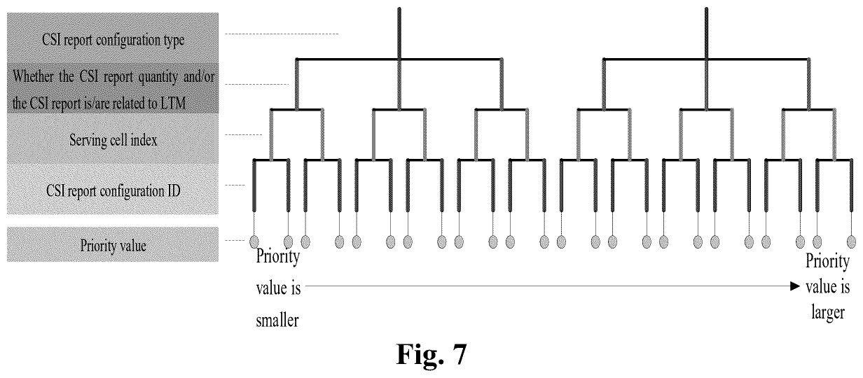

FIG. 7 is another exemplary diagram of determining the first priority value and/or the second priority value of the embodiments of this disclosure. Formula (2) may be expressed as a tree diagram of FIG. 7. Both the first priority value and the second priority value may be determined according to formula (2). A difference from formula (2) is that the value range of k is expanded in formula (2), thereby adding new branches to the first CSI report.

For example, the first priority value or the second priority value are determined according to the mode shown in FIG. 7 and formula (2). Hence, the first CSI report and the second CSI report do not have identical priority values, thereby solving the problem of ambiguity generated in determining the priorities of the CSI reports. In a case where the priority values are different, a CSI report with a smaller priority value has a higher priority.

In some embodiments, the first priority value and/or the second priority value is/are determined according to a parameter representing a CSI report configuration identifier, a parameter representing a serving cell index, a parameter representing a CSI report quantity, a parameter representing a CSI report configuration type and whether a CSI report is related to LTM or not.

The first priority value and the second priority value are expressed as Pri_{CSI}, Pri_{CSI} being determined according to formula (3) below:

$$P r {i}_{CSI} ( y , k , c , s ) = {M}_{y} \cdot {M}_{k} \cdot {N}_{c e l l s} \cdot {M}_{s} \cdot x + {M}_{k} \cdot {N}_{c e l l s} \cdot {M}_{s} \cdot y + {N}_{c e l l s} \cdot {M}_{s} \cdot k + {M}_{s} \cdot c + s ; \qquad ( 3 )$$

where,
x denotes whether the CSI report is related to LTM; for example, when the CSI report is not related to LTM (a legacy CSI report), x=0; when the CSI report is related to LTM (an LTM CSI report), x=1. Which CSI report corresponds to a value of x is not limited in this disclosure. For example, the above two CSI reports may also be that: a legacy CSI report corresponds to x=1, and an LTM CSI report corresponds to x=0; for example, x may also be other values, which shall not be enumerated herein any further.

M_{y}−1 denotes a maximum value of y. For example, a definition of y is identical to that in formula (1), and M_{y}=4.

Definitions of other parameters are identical to those in formula (1).

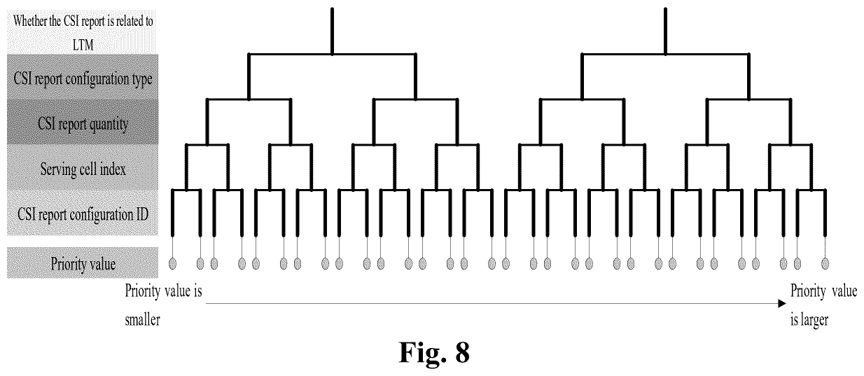

FIG. 8 is a further exemplary diagram of determining the first priority value and/or the second priority value of the embodiments of this disclosure. Formula (3) may be expressed as a tree diagram of FIG. 8. Both the first priority value and the second priority value may be determined according to formula (3).

For example, the first priority value or the second priority value are determined according to the mode shown in FIG. 8 and formula (3). A new parameter x is introduced into formula (3), thus adding a new branch to the first CSI report. Hence, the first CSI report and the second CSI report do not have identical priority values, thereby solving the problem of ambiguity generated in determining the priorities of the CSI reports.

In FIG. 8, the newly-introduced parameter x is located in a first branch (counting from top to bottom). When the parameter x is located in the first branch, Pri_{CSI} is determined according to formula (3); likewise, the parameter x may be located in a second, third, fourth, and fifth branches.

Cases where the parameter x is located in different branches shall be described below

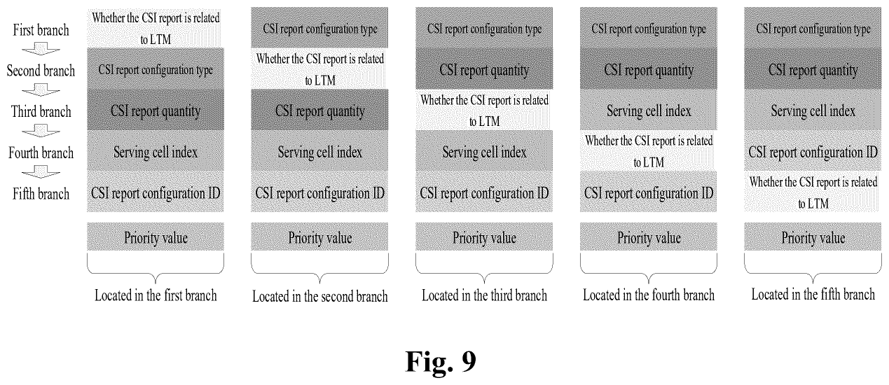

FIG. 9 is still another exemplary diagram of determining the first priority value and/or the second priority value of the embodiments of this disclosure. As shown in FIG. 9, when the parameter x is located in the second branch, Pri_{CSI} is determined according to formula (4);

$$P r {i}_{CSI} ( y , k , c , s ) = {M}_{x} \cdot {M}_{k} \cdot {N}_{c e l l s} \cdot {M}_{s} \cdot y + {M}_{k} \cdot {N}_{c e l l s} \cdot {M}_{s} \cdot x + {N}_{c e l l s} \cdot {M}_{s} \cdot k + {M}_{s} \cdot c + s ; \qquad ( 4 )$$

where,
Mₓ−1 denotes a maximum value of x. For example, a definition of x is identical to that in formula (3), and Mₓ=2.

Definitions of other parameters are identical to those in formula (3).

When the parameter x is located in the third branch, Pri_{CSI} is determined according to formula (5):

$$P r {i}_{CSI} ( y , k , c , s ) = {M}_{k} \cdot {M}_{x} \cdot {N}_{c e l l s} \cdot {M}_{s} \cdot y + {M}_{x} \cdot {N}_{c e l l s} \cdot {M}_{s} \cdot k + {N}_{c e l l s} \cdot {M}_{s} \cdot x + {M}_{s} \cdot c + s ; \qquad ( 5 )$$

When the parameter x is located in the fourth branch, Pri_{CSI} is determined according to formula (6):

$$P r {i}_{CSI} ( y , k , c , s ) = {M}_{k} \cdot {N}_{c e l l s} \cdot {M}_{x} \cdot {M}_{s} \cdot y + {N}_{c e l l s} \cdot {M}_{x} \cdot {M}_{s} \cdot k + {M}_{x} \cdot {M}_{s} \cdot c + {M}_{s} \cdot x + s ; \qquad ( 6 )$$

When the parameter x is located in the fifth branch, Pri_{CSI} is determined according to formula (7):

$$P r {i}_{CSI} ( y , k , c , s ) = {M}_{k} \cdot {N}_{c e l l s} \cdot {M}_{s} \cdot {M}_{x} \cdot y + {N}_{c e l l s} \cdot {M}_{s} \cdot {M}_{x} \cdot k + {M}_{s} \cdot {M}_{x} \cdot c + {M}_{x} \cdot s + x ; \qquad ( 7 )$$

For example, for formulas (5)-(7), definitions of the parameters are identical to those in formula (4), for example, formulas (4)-(7) are variants of formula (3). Therefore, after the first priority value and/or the second priority value is/are determined according to formulas (4)-(7), the first CSI report and the second CSI report do not have identical priority values, thereby solving the problem of ambiguity generated in determining the priorities of the CSI reports.

For example, the first priority value of the first CSI report and the second priority value of the second CSI report are determined according to the above formulas. For example, the first priority value and the second priority value determined according to formula (1) may be identical, and the first priority value and the second priority value determined according to formulas (2)-(7) may not be identical.

For example, for formula (1), in a case where the determined first priority value and second priority value are identical, ambiguities will occur in determining the priorities, and the problem of ambiguity generated in determining the priorities of the CSI reports may be solved by using the methods described above. For example, the priority of the first CSI report is limited to be higher by the first rule, or the priority of the second CSI report is limited to be higher by the first rule. For another example, the first rule includes that: when the first priority value is identical to the second priority value, the priority of the first CSI report to which the first priority value corresponds is higher than the second CSI report to which the second priority value corresponds, or, when the first priority value is identical to the second priority value, the priority of the second CSI report to which the second priority value corresponds is higher than the first CSI report to which the first priority value corresponds. For formulas (2)-(7), as the determined first priority value and second priority value are not identical, no ambiguity will be generated in determining “the priorities of the first CSI report and the second CSI report”. According to a principle of “the smaller a priority value of a CSI report, the higher a priority of the CSI report”, “the priorities of the first CSI report and the second CSI report” may be determined. The problem of ambiguity generated in determining the priorities of the CSI reports is solved by formulas (2)-(7).

The above implementations only illustrate the embodiments of this disclosure. However, this disclosure is not limited thereto, and appropriate variants may be made on the basis of these implementations. For example, the above implementations may be executed separately, or one or more of them may be executed in a combined manner.

It can be seen from the above embodiments that the terminal equipment is configured with a CSI report and/or a second CSI report, a priority/priorities of the first channel state information report and/or the second channel state information report is/are determined, and the first channel state information report and/or the second channel state information report is/are transmitted according to determined priority/priorities. Thus, ambiguities resulted from determining a priority of a CSI report may be avoided, and failures in transmission of the CSI report caused thereby may also be avoided.

### EMBODIMENTS OF A SECOND ASPECT

The embodiments of this disclosure provide a data reception method, applicable to a network device side. The embodiments of this disclosure may be combined with the embodiments of the first aspect, or may be implemented separately. Contents identical to those in the embodiments of the first aspect shall not be repeated herein any further.

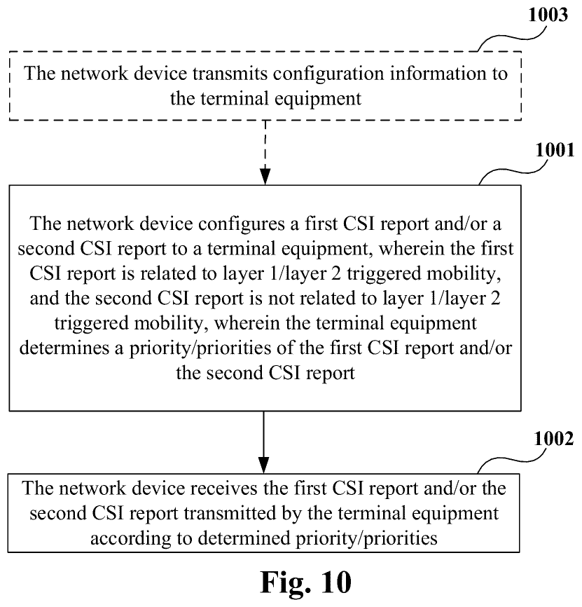

FIG. 10 is a schematic diagram of a data reception method of the embodiments of this disclosure. As shown in FIG. 10, the method includes:

1001: the network device configures a first channel state information report and/or a second channel state information report to a terminal equipment, wherein the first channel state information report is related to layer 1/layer 2 triggered mobility, and the second channel state information report is not related to layer 1/layer 2 triggered mobility, wherein the terminal equipment determines a priority/priorities of the first channel state information report and/or the second channel state information report; and

1002: the network device receives the first channel state information report and/or the second channel state information report transmitted by the terminal equipment according to determined priority/priorities.

Thus, the terminal equipment is configured with a CSI report and/or a second CSI report, determines a priority/priorities of the first channel state information report and/or the second channel state information, and transmits the first channel state information report and/or the second channel state information report according to determined priority/priorities. Hence, ambiguities resulted from determining a priority of a CSI report may be avoided, and failures in transmission of the CSI report caused thereby may also be avoided.

In some embodiments, the term “a network device” may be equivalently replaced with, for example, “a serving cell” or “a source cell” or “a target cell”.

In some embodiments, configuring the first CSI report and/or the second CSI report includes: not configuring the first CSI report and the second CSI report having identical priority values.

In some embodiments, configuring the first CSI report and/or the second CSI report includes: not configuring the first CSI report and the second CSI report having identical CSI report configuration IDs.

In some embodiments, the method further includes: 1003: the network device transmits configuration information to the terminal equipment, wherein the configuration information configures the first CSI report and/or the second CSI report.

In some embodiments, the configuration information is carried by an RRC message.

It should be noted that FIG. 10 only schematically illustrates the embodiments of this disclosure, and the terminal equipment is taken as an example; however, this disclosure is not limited thereto. For example, an order of execution of the operations may be appropriately adjusted, and furthermore, some other operations may be added, or some operation therein may be reduced. Furthermore, objects of the above operations may be adjusted. And appropriate variants may be made by those skilled in the art according to the above contents, without being limited to what is contained in FIG. 10.

The above implementations only illustrate the embodiments of this disclosure. However, this disclosure is not limited thereto, and appropriate variants may be made on the basis of these implementations. For example, the above implementations may be executed separately, or one or more of them may be executed in a combined manner.

It can be seen from the above embodiments that the terminal equipment is configured with a CSI report and/or a second CSI report, a priority/priorities of the first channel state information report and/or the second channel state information report is/are determined, and the first channel state information report and/or the second channel state information report is/are transmitted according to determined priority/priorities. Thus, ambiguities resulted from determining a priority of a CSI report may be avoided, and failures in transmission of the CSI report caused thereby may also be avoided.

### EMBODIMENTS OF A THIRD ASPECT

The embodiments of this disclosure provide a data transmission apparatus. The apparatus may be, for example, a terminal equipment, or one or some components or assemblies configured in the terminal equipment. Contents in the embodiments identical to those in the embodiments of the first aspect shall not be described herein any further.

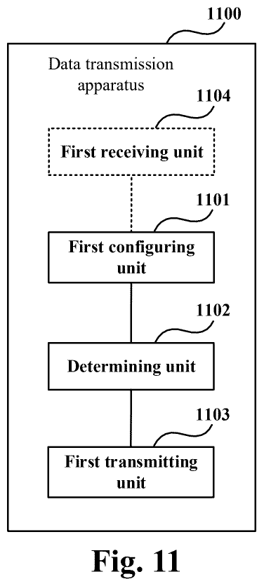

FIG. 11 is a schematic diagram of the data transmission apparatus of the embodiments of this disclosure. As shown in FIG. 11, the data transmission apparatus 1100 includes:
a first configuration unit 1101 configured with a first channel state information report and/or a second channel state information report, wherein the first channel state information report is related to layer 1/layer 2 triggered mobility, and the second channel state information report is not related to layer 1/layer 2 triggered mobility;
a determining unit 1102 configured to determine a priority/priorities of the first channel state information report and/or the second channel state information report; and
a first transmitting unit 1103 configured to transmit the first channel state information report and/or the second channel state information report according to determined priority/priorities.

The terminal equipment is configured with a CSI report and/or a second CSI report, a priority/priorities of the first channel state information report and/or the second channel state information report is/are determined, and the first channel state information report and/or the second channel state information report is/are transmitted according to determined priority/priorities. Thus, ambiguities resulted from determining a priority of a CSI report may be avoided, and failures in transmission of the CSI report caused thereby may also be avoided.

In some embodiments, the determining unit 1102 determines the priority/priorities of the first channel state information report and/or the second channel state information report according to at least one of the following: a first priority value of the first channel state information report; a second priority value of the second channel state information report; or, a first rule.

In some embodiments, the smaller the first priority value, the higher a corresponding priority of the first channel state information report, and/or the smaller the second priority value, the higher a corresponding priority of the second channel state information report.

In some embodiments, the first transmitting unit 1103 transmits the first channel state information report or the second channel state information report whichever has a higher priority.

In some embodiments, the first rule comprises that: in a case where the first priority value is identical to the second priority value, a priority of the first channel state information report to which the first priority value corresponds is higher than the second channel state information report to which the second priority value corresponds, or, in a case where the first priority value is identical to the second priority value, a priority of the second channel state information report to which the second priority value corresponds is higher than the first channel state information report to which the first priority value corresponds.

In some embodiments, the first configuration unit 1101 further, does not expect to be configured with the first channel state information report and the second channel state information report having identical priority values.

In some embodiments, the first configuration unit 1101 further, does not expect to be configured with the first channel state information report and the second channel state information report having identical channel state information report configuration identifiers.

In some embodiments, the first transmitting unit 1103 further, does not expect to simultaneously transmit the first channel state information report and the second channel state information report.

In some embodiments, the first transmitting unit 1103 further, does not expect to simultaneously transmit the first channel state information report and the second channel state information report having identical priority values.

In some embodiments, the first transmitting unit 1103 further, does not expect to simultaneously transmit the first channel state information report and the second channel state information report having identical channel state information report configuration identifiers.

In some embodiments, that does not expect to simultaneously transmit the first channel state information report and the second channel state information report includes that: the first transmitting unit 1103 does not expect to simultaneously transmit the first channel state information report and the second channel state information report in a cell.

In some embodiments, the first rule includes: deeming that the priority of the first channel state information report is higher than the priority of the second channel state information report, or deeming that the priority of the second channel state information report is higher than the priority of the first channel state information report.

In some embodiments, the first priority value and/or the second priority value is/are determined according to at least one of the following: a channel state information report configuration identifier; a serving cell index; a channel state information report quantity; a channel state information report configuration type; or, whether a channel state information report is related to layer 1/layer 2 triggered mobility.

In some embodiments, the data transmission apparatus 1100 further includes: a first receiving unit 1104 configured to receive configuration information, wherein the configuration information configures the first channel state information report and/or the second channel state information report.

In some embodiments, the configuration information is carried by a radio resource control (RRC) message.

The above implementations only illustrate the embodiments of this disclosure. However, this disclosure is not limited thereto, and appropriate variants may be made on the basis of these implementations. For example, the above implementations may be executed separately, or one or more of them may be executed in a combined manner.

It should be noted that the components or modules related to this disclosure are only described above. However, this disclosure is not limited thereto, and the data transmission apparatus 1100 may further include other components or modules, and reference may be made to related techniques for particulars of these components or modules.

Furthermore, for the sake of simplicity, connection relationships between the components or modules or signal profiles thereof are only illustrated in FIG. 11. However, it should be understood by those skilled in the art that such related techniques as bus connection, etc., may be adopted. And the above components or modules may be implemented by hardware, such as a processor, a memory, a transmitter, and a receiver, etc., which are not limited in the embodiments of this disclosure.

It can be seen from the above embodiments that the terminal equipment is configured with a CSI report and/or a second CSI report, a priority/priorities of the first channel state information report and/or the second channel state information report is/are determined, and the first channel state information report and/or the second channel state information report is/are transmitted according to determined priority/priorities. Thus, ambiguities resulted from determining a priority of a CSI report may be avoided, and failures in transmission of the CSI report caused thereby may also be avoided.

### EMBODIMENTS OF A FOURTH ASPECT

The embodiments of this disclosure provide a data reception apparatus. The apparatus may be, for example, a network device, or one or some components or assemblies configured in the network device. Contents in the embodiments identical to those in the embodiments of the second aspect shall not be described herein any further.

FIG. 12 is a schematic diagram of the data reception apparatus of the embodiments of this disclosure. As shown in FIG. 12, the data reception apparatus 1200 includes:
a second configuration unit 1201 configured to configure a first channel state information report and/or a second channel state information report to a terminal equipment, wherein the first channel state information report is related to layer 1/layer 2 triggered mobility, and the second channel state information report is not related to layer 1/layer 2 triggered mobility, wherein the terminal equipment determines a priority/priorities of the first channel state information report and/or the second channel state information report; and
a second receiving unit 1202 configured to receive the first channel state information report and/or the second channel state information report transmitted by the terminal equipment according to determined priority/priorities.

Thus, the terminal equipment is configured with a CSI report and/or a second CSI report, determines a priority/priorities of the first channel state information report and/or the second channel state information, and transmits the first channel state information report and/or the second channel state information report according to determined priority/priorities. Hence, ambiguities resulted from determining a priority of a CSI report may be avoided, and failures in transmission of the CSI report caused thereby may also be avoided.

In some embodiments, the second configuration unit 1201 further, does not configure the first channel state information report and the second channel state information report having identical priority values.

In some embodiments, the second configuration unit 1201 further, does not configure the first channel state information report and the second channel state information report having identical channel state information report configuration identifiers.

In some embodiments, the data reception apparatus 1200 further includes: a second transmitting unit 1203 configured to transmit configuration information, wherein the configuration information configures the first channel state information report and/or the second channel state information report.

In some embodiments, the configuration information is carried by a radio resource control (RRC) message.

The above implementations only illustrate the embodiments of this disclosure. However, this disclosure is not limited thereto, and appropriate variants may be made on the basis of these implementations. For example, the above implementations may be executed separately, or one or more of them may be executed in a combined manner.

It should be noted that the components or modules related to this disclosure are only described above. However, this disclosure is not limited thereto, and the data reception apparatus 1200 may further include other components or modules, and reference may be made to related techniques for particulars of these components or modules.

Furthermore, for the sake of simplicity, connection relationships between the components or modules or signal profiles thereof are only illustrated in FIG. 12. However, it should be understood by those skilled in the art that such related techniques as bus connection, etc., may be adopted. And the above components or modules may be implemented by hardware, such as a processor, a memory, a transmitter, and a receiver, etc., which are not limited in the embodiments of this disclosure.

It can be seen from the above embodiments that the terminal equipment is configured with a CSI report and/or a second CSI report, determines a priority/priorities of the first channel state information report and/or the second channel state information, and transmits the first channel state information report and/or the second channel state information report according to determined priority/priorities. Hence, ambiguities resulted from determining a priority of a CSI report may be avoided, and failures in transmission of the CSI report caused thereby may also be avoided.

### EMBODIMENTS OF A FIFTH ASPECT

The embodiments of this disclosure provide a communication system, and reference may be made to FIG. 1, with contents identical to those in the embodiments of the first to the fourth aspects being not going to be described herein any further.

In some embodiments, the communication system 100 may at least include a network device and a terminal equipment, wherein,
the network device is configured to configure a first channel state information report and/or a second channel state information report; and
the terminal equipment is configured with the first channel state information report and/or the second channel state information report by the network device, wherein the first channel state information report is related to layer 1/layer 2 triggered mobility, and the second channel state information report is not related to layer 1/layer 2 triggered mobility; configured to determine a priority/priorities of the first channel state information report and/or the second channel state information report; and configured to transmit the first channel state information report and/or the second channel state information report according to determined priority/priorities.

Thus, the terminal equipment is configured with a CSI report and/or a second CSI report, determines a priority/priorities of the first channel state information report and/or the second channel state information, and transmits the first channel state information report and/or the second channel state information report according to determined priority/priorities. Hence, ambiguities resulted from determining a priority of a CSI report may be avoided, and failures in transmission of the CSI report caused thereby may also be avoided.

The embodiments of this disclosure further provide a network device, which may be, for example, a base station. However, this disclosure is not limited thereto, and it may also be another network device.

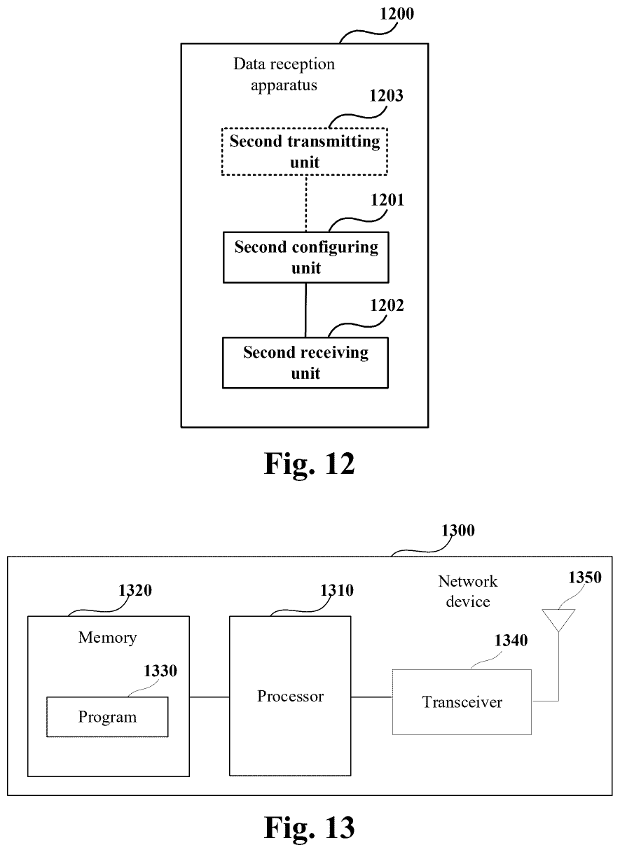

FIG. 13 is a schematic diagram of a structure of the network device of the embodiments of this disclosure. As shown in FIG. 13, the network device 1300 may include a processor 1310 (such as a central processing unit (CPU)) and a memory 1320, the memory 1320 being coupled to the processor 1310. Wherein, the memory 1320 may store various data, and furthermore, it may store a program 1330 for information processing, and execute the program 1330 under control of the processor 1310.

Furthermore, as shown in FIG. 13, the network device 1300 may include a transceiver 1340, and an antenna 1350, etc. Wherein, functions of the above components are similar to those in the related art, and shall not be described herein any further. It should be noted that the network device 1300 does not necessarily include all the parts shown in FIG. 13, and furthermore, the network device 1300 may include parts not shown in FIG. 13, and the related art may be referred to.

The embodiments of this disclosure further provide a terminal equipment; however, this disclosure is not limited thereto, and it may also be another equipment.

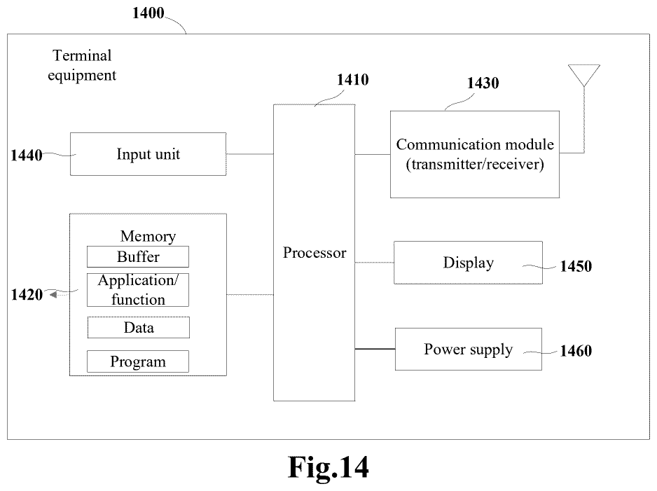

FIG. 14 is a schematic diagram of the terminal equipment of the embodiments of this disclosure. As shown in FIG. 14, the terminal equipment 1400 may include a processor 1410 and a memory 1420, the memory 1420 storing data and a program and being coupled to the processor 1410. It should be noted that this figure is illustrative only, and other types of structures may also be used, so as to supplement or replace this structure and achieve a telecommunications function or other functions.

For example, the processor 1410 may be configured to execute a program to carry out the data transmission method as described in the embodiments of the first aspect. For example, the processor 1410 may be configured to execute the following control: a terminal equipment configured with a first channel state information (CSI) report and/or a second CSI report, wherein the first channel state information report is related to layer 1/layer 2 triggered mobility, and the second channel state information report is not related to layer 1/layer 2 triggered mobility; determining a priority/priorities of the first channel state information report and/or the second channel state information report; and transmitting the first channel state information report and/or the second channel state information report according to determined priority/priorities.

As shown in FIG. 14, the terminal equipment 1400 may further include a communication module 1430, an input unit 1440, a display 1450, and a power supply 1460; wherein functions of the above components are similar to those in the related art, which shall not be described herein any further. It should be noted that the terminal equipment 1400 does not necessarily include all the parts shown in FIG. 14, and the above components are not necessary. Furthermore, the terminal equipment 1400 may include parts not shown in FIG. 14, and the related art may be referred to.

The embodiments of this disclosure provide a computer program, which, when executed in a terminal equipment, will cause the terminal equipment to carry out the data transmission method as described in the embodiments of the first aspect.

The embodiments of this disclosure provide a storage medium, including a computer program, which will cause a terminal equipment to carry out the data transmission method as described in the embodiments of the first aspect.

The embodiments of this disclosure provide a computer program, which, when executed in a terminal equipment, will cause the terminal equipment to carry out the data reception method as described in the embodiments of the second aspect.

The embodiments of this disclosure provide a storage medium, including a computer program, which will cause a terminal equipment to carry out the data reception method as described in the embodiments of the second aspect.

The above apparatuses and methods of this disclosure may be implemented by hardware, or by hardware in combination with software. This disclosure relates to such a computer-readable program that when the program is executed by a logic device, the logic device is enabled to carry out the apparatus or components as described above, or to carry out the methods or steps as described above. This disclosure also relates to a storage medium for storing the above program, such as a hard disk, a floppy disk, a CD, a DVD, and a flash memory, etc.

The methods/apparatuses described with reference to the embodiments of this disclosure may be directly embodied as hardware, software modules executed by a processor, or a combination thereof. For example, one or more functional block diagrams and/or one or more combinations of the functional block diagrams shown in the drawings may either correspond to software modules of procedures of a computer program, or correspond to hardware modules. Such software modules may respectively correspond to the steps shown in the drawings. And the hardware module, for example, may be carried out by firming the soft modules by using a field programmable gate array (FPGA).

The soft modules may be located in an RAM, a flash memory, an ROM, an EPROM, and EEPROM, a register, a hard disc, a floppy disc, a CD-ROM, or any memory medium in other forms known in the art. A memory medium may be coupled to a processor, so that the processor may be able to read information from the memory medium, and write information into the memory medium; or the memory medium may be a component of the processor. The processor and the memory medium may be located in an ASIC. The soft modules may be stored in a memory of a mobile terminal, and may also be stored in a memory card of a pluggable mobile terminal. For example, if equipment (such as a mobile terminal) employs an MEGA-SIM card of a relatively large capacity or a flash memory device of a large capacity, the soft modules may be stored in the MEGA-SIM card or the flash memory device of a large capacity.

One or more functional blocks and/or one or more combinations of the functional blocks in the drawings may be realized as a universal processor, a digital signal processor (DSP), an application-specific integrated circuit (ASIC), a field programmable gate array (FPGA) or other programmable logic devices, discrete gate or transistor logic devices, discrete hardware component or any appropriate combinations thereof carrying out the functions described in this application. And the one or more functional block diagrams and/or one or more combinations of the functional block diagrams in the drawings may also be realized as a combination of computing equipment, such as a combination of a DSP and a microprocessor, multiple processors, one or more microprocessors in communication combination with a DSP, or any other such configuration.

This disclosure is described above with reference to particular embodiments. However, it should be understood by those skilled in the art that such a description is illustrative only, and not intended to limit the protection scope of the present disclosure. Various variants and modifications may be made by those skilled in the art according to the spirits and principle of the present disclosure, and such variants and modifications fall within the scope of the present disclosure.

As to implementations containing the above embodiments, following supplements are further disclosed.

1. A data transmission method, applicable to a terminal equipment, the method including:
being configured with a first channel state information (CSI) report and/or a second CSI report, wherein the first CSI report is related to layer 1/layer 2 triggered mobility, and the second CSI report is not related to layer 1/layer 2 triggered mobility;
determining a priority/priorities of the first CSI report and/or the second CSI report; and
transmitting the first CSI report and/or the second CSI report according to determined priority/priorities.

2. The method according to supplement 1, wherein the priority/priorities of the first CSI report and/or the second CSI report is/are determined according to at least one of the following:
a first priority value of the first CSI report;
a second priority value of the second CSI report; or,
a first rule.

3. The method according to supplement 2, wherein the smaller the first priority value, the higher a corresponding priority of the first CSI report, and/or the smaller the second priority value, the higher a corresponding priority of the second CSI report.

4. The method according to supplement 2, wherein the transmitting the first CSI report and/or the second CSI report includes:
transmitting the first CSI report or the second CSI report whichever has a higher priority.

5. The method according to supplement 4, wherein the first rule includes that:
in a case where the first priority value is identical to the second priority value, a priority of the first CSI report to which the first priority value corresponds is higher than the second CSI report to which the second priority value corresponds, or,
in a case where the first priority value is identical to the second priority value, a priority of the second CSI report to which the second priority value corresponds is higher than the first CSI report to which the first priority value corresponds.

6. The method according to supplement 2, wherein the being configured with a first channel state information (CSI) report and/or a second CSI report includes:
not expecting to be configured with the first CSI report and the second CSI report having identical priority values.

7. The method according to supplement 2, wherein the being configured with a first channel state information (CSI) report and/or a second CSI report includes:
not expecting to be configured with the first CSI report and the second CSI report having identical CSI report configuration identifiers.

8. The method according to supplement 2, wherein the transmitting the first CSI report and/or the second CSI report includes:
not expecting to simultaneously transmit the first CSI report and the second CSI report.

9. The method according to supplement 2, wherein the transmitting the first CSI report and/or the second CSI report includes:
not expecting to simultaneously transmit the first CSI report and the second CSI report having identical priority values.

10. The method according to supplement 2, wherein the transmitting the first CSI report and/or the second CSI report includes:
not expecting to simultaneously transmit the first CSI report and the second CSI report having identical CSI report configuration identifiers.

11. The method according to supplement 8 or 9 or 10, wherein the not expecting to simultaneously transmit the first CSI report and the second CSI report includes:
not expecting to simultaneously transmit the first CSI report and the second CSI report in a cell.

12. The method according to supplement 4, wherein the first rule includes: deeming that a priority of the first CSI report is higher than a priority of the second CSI report, or deeming that a priority of the second CSI report is higher than a priority of the first CSI report.

13. The method according to supplement 2, wherein the first priority value and/or the second priority value is/are determined according to at least one of the following:
a CSI report configuration identifier;
a serving cell index;
a CSI report quantity;
a CSI report configuration type; or
whether a CSI report is related to layer 1/layer 2 triggered mobility.

14. The method according to supplement 1, wherein the method further includes:
receiving configuration information, wherein the configuration information configures the first CSI report and/or the second CSI report.

15. The method according to supplement 14, wherein the configuration information is carried by an RRC message.

16. A data reception method, applicable to a network device, the method including:
configuring a first channel state information report and/or a second channel state information report to a terminal equipment, wherein the first channel state information report is related to layer 1/layer 2 triggered mobility, and the second channel state information report is not related to layer 1/layer 2 triggered mobility,
wherein the terminal equipment determines a priority/priorities of the first channel state information report and/or the second channel state information report; and
receiving the first channel state information report and/or the second channel state information report transmitted by the terminal equipment according to determined priority/priorities.

17. The method according to supplement 16, wherein the configuring a first CSI report and/or a second CSI report includes:
not configuring the first CSI report and the second CSI report having identical priority values.

18. The method according to supplement 16, wherein the configuring a first CSI report and/or a second CSI report includes:
not configuring the first CSI report and the second CSI report having identical CSI report configuration identifiers.

19. The method according to supplement 16, wherein the method further includes:
transmitting configuration information, wherein the configuration information configures the first CSI report and/or the second CSI report.

20. The method according to supplement 19, wherein the configuration information is carried by an RRC message.

21. A terminal equipment, including a memory and a processor, the memory storing a computer program, and the processor being configured to execute the computer program to carry out the method as described in any one of supplements 1-16.

22. A network device, including a memory and a processor, the memory storing a computer program, and the processor being configured to execute the computer program to carry out the method as described in any one of supplements 17-20.

23. A communication system, including:
a network device configured to configure a first channel state information report and/or a second channel state information report; and
a terminal equipment configured with the first channel state information report and/or the second channel state information report by the network device, wherein the first channel state information report is related to layer 1/layer 2 triggered mobility, and the second channel state information report is not related to layer 1/layer 2 triggered mobility; configured to determine a priority/priorities of the first channel state information report and/or the second channel state information report; and configured to transmit the first channel state information report and/or the second channel state information report according to determined priority/priorities.

1. A data transmission apparatus, configured in a terminal equipment, the data transmission apparatus comprising:
first configuration processor circuitry configured with a first channel state information report and/or a second channel state information report, wherein the first channel state information report is related to layer 1/layer 2 triggered mobility, and the second channel state information report is not related to layer 1/layer 2 triggered mobility;
determining processor circuitry configured to determine a priority/priorities of the first channel state information report and/or the second channel state information report; and
a first transmitter configured to transmit the first channel state information report and/or the second channel state information report according to determined priority/priorities,
wherein a priority of the first channel state information report is higher than a priority of the second channel state information report.

2. The apparatus according to claim 1, wherein the smaller a first priority value of the first channel state information report, the higher a corresponding priority of the first channel state information report, and/or the smaller a second priority value of the second channel state information report, the higher a corresponding priority of the second channel state information report.

3. The apparatus according to claim 2, wherein the first transmitter transmits the first channel state information report or the second channel state information report whichever has a higher priority.

4. The apparatus according to claim 2, wherein the first priority value and/or the second priority value is/are determined according to at least one of the following:
a first channel state information report configuration identifier;
a second channel state information report configuration identifier;
a serving cell index;
a channel state information report quantity; or
a channel state information report configuration type.

5. The apparatus according to claim 4, wherein the first channel state information report configuration identifier used for determining the first priority value is larger than or equal to 0 and smaller than a first parameter, and/or
the second channel state information report configuration identifier used for determining the second priority value is larger than or equal to 0 and smaller than a second parameter.

6. The apparatus according to claim 1, the data transmission apparatus further comprising:
a first receiver configured to receive configuration information, wherein the configuration information configures the first channel state information report and/or the second channel state information report.

7. The apparatus according to claim 6, wherein
the configuration information used for configuring the first channel state information report is provided by a third parameter ltm-CSI-ReportConfigToAddModList;
the configuration information used for configuring the second channel state information report is provided by a fourth parameter csi-ReportConfigToAddModList;
the third parameter and the fourth parameter are configured within a fifth parameter CSI-MeasConfig.

8. The apparatus according to claim 6, wherein the configuration information is carried by a radio resource control (RRC) message.

9. A data reception apparatus, configured in a network device, the data reception apparatus comprising:
second configuration processor circuitry configured to configure a first channel state information report and/or a second channel state information report to a terminal equipment, wherein the first channel state information report is related to layer 1/layer 2 triggered mobility, and the second channel state information report is not related to layer 1/layer 2 triggered mobility, wherein the terminal equipment determines a priority/priorities of the first channel state information report and/or the second channel state information report, a priority of the first channel state information report being higher than a priority of the second channel state information report; and
a second receiver configured to receive the first channel state information report and/or the second channel state information report transmitted by the terminal equipment according to determined priority/priorities.

10. The apparatus according to claim 9, wherein the second configuration processor circuitry further,
does not configure the first channel state information report and the second channel state information report having identical priority values.

11. The apparatus according to claim 9, wherein the second configuration processor circuitry further,
does not configure the first channel state information report and the second channel state information report having identical channel state information report configuration identifiers.

12. The apparatus according to claim 9, the data reception apparatus further comprising a second transmitter configured to transmit configuration information, wherein the configuration information configures the first channel state information report and/or the second channel state information report.

13. A communication system, comprising:
a network device configured to configure a first channel state information report and/or a second channel state information report; and
a terminal equipment configured with the first channel state information report and/or the second channel state information report by the network device, wherein the first channel state information report is related to layer 1/layer 2 triggered mobility, and the second channel state information report is not related to layer 1/layer 2 triggered mobility; configured to determine a priority/priorities of the first channel state information report and/or the second channel state information report; and configured to transmit the first channel state information report and/or the second channel state information report according to determined priority/priorities, a priority of the first channel state information report being higher than a priority of the second channel state information report.
